(19) United States
(12) Patent Application Publication
(10) Pub. No.: US 2011/0193296 A1
(43) Pub. Date: Aug. 11, 2011

(54) TRIM RETAINER/SEAL

(76) Inventor: Rod Bara, Rochester Hills, MI (US)

(21) Appl. No.: 13/003,696

(22) PCT Filed: Jul. 10, 2009
(86) PCT No.: PCT/US09/50261

§ 371 Date: Apr. 26, 2011

Related U.S. Application Data
(60) Provisional application No. 61/080,135, filed on Jul. 11, 2008.

(51) Int. Cl. B60J 10/00; B23P 11/00

(52) U.S. Cl. 277/630; 29/525.01

(57) ABSTRACT

A trim or weatherstrip assembly secured to an associated vehicle. The assembly includes a cover portion that overlies an associated vehicle adjacent an edge. A connection member is defined on the cover portion. A fastener portion includes a detent connection member having first and second portions for operatively and alternatively engaging the connection member in a shipping, first position and in an installed, second position.

### BACKGROUND OF THE DISCLOSURE

This disclosure relates to an apparatus and method of retaining a weatherstrip or trim component, for example, along an edge of a vehicle sheet metal and other automotive applications where a trim part is used to enhance the vehicle's appearance, as well as help the functionality and cover the sheet metal in selected locations. Examples of such trims are a door pillar trim, hood to cowl trim, hood to fender trim, hood to radiator trim, and liftgate and sliding panel trim, and in some instances may include a seal as a part of the trim and occasionally referred to as a weatherstrip or weatherseal. It will be appreciated, however, that this list of potential areas of applications is not exhaustive and that the present disclosure may find application in related environments and uses.

As noted above, one area where an improved trim is required is associated with retaining a B-pillar trim to door sheet metal, and particularly along the cut-line edge of the sheet metal. Present arrangements use clips or separate parts to cover the trim edge on the door and also to isolate that component from vibration noise. These clips are separate parts and tend to require a rotational motion during installation to assure that the door metal trim edge is covered and that the component is retained in place. For example, the trim or appliqué is wrapped around the edge so that there is no exposed sheet metal edge. The wrap-around feature necessarily requires the trim panel to hook along the edge and then rotate into position. Moreover, the trim usually needs to be slid into position because of the curvature associated with the vehicle. This complicates the appliquéstructure to incorporate the wrap-around feature. The mounting arrangement usually requires the fasteners on the B-pillar to secure the appliqué, that is, the fasteners are usually on the show or flat planar surface of the B-pillar and extend into the sheet metal. This procedure limits the amount of flange that can be covered, and also limits the length of a below belt portion of a glass run channel, for example, due to the limitations associated with installation. Current applications also have the potential to damage painted surfaces as a result of this complex mounting method.

There is always a need to use inexpensive materials for the trim component, as well as any means for securing the trim component to the vehicle. Limiting the number of fasteners would also be a desired goal since less components results in reduced handling and reduced costs associated with assembly and installation. Simplified installation also contributes to reduced costs as well as assuring a reliable, repeatable installation.

Therefore, a need exists for an improved weatherstrip or trim member, and retainer, and associated method of manufacturing and installing such a weatherstrip or trim to a vehicle.

### SUMMARY OF THE DISCLOSURE

A trim assembly, such as a trim member, includes a cover portion dimensioned to overlie a region of an associated vehicle adjacent an edge. A connection member is operatively associated with the cover portion. A fastener portion is dimensioned for engaging receipt on the associated vehicle and includes a detent connection member having first and second portions for operatively and alternatively engaging the connection member in a shipping, first position and in an installed, second position.

The detent connection member preferably includes a first shoulder that engages the connection member in a shipping position and a second shoulder spaced from the first shoulder that engages the connection member in the installed position.

In selected embodiments, a seal member extends outwardly from one of the trim or the fastener portion for engagement with the associated vehicle.

The fastener portion preferably includes a first hook member dimensioned for receipt over the associated edge of the vehicle.

The trim is preferably one of an elastomer or plastomer.

A method of manufacturing the trim assembly includes providing a cover portion dimensioned to overlie an associated vehicle adjacent an edge and a connection member operatively associated therewith. The method further includes providing a fastener portion dimensioned for engaging receipt on the associated vehicle and including a detent connection member that includes first and second portions for operatively and alternatively engaging the connection member in a shipping, first position and in an installed, second position.

The method includes forming the connection member as a channel dimensioned to receive the detent connection member therethrough.

The method further includes forming the detent connection member as first and second shoulders spaced apart in a direction of insertion into the connection member, and preferably the first shoulder extending a first height above the detent connection member and the second shoulder extending a different, second height above the detent connection member.

A method includes extruding the fastener portion, and in a preferred embodiment co-extruding a flexible seal.

The method further includes cutting the extruded fastener portion into individual segments.

A method of installing a trim to an associated vehicle includes advancing the trim generally perpendicular to a cover region with the detent connection member in the shipping position and subsequently moving the detent connection member to the installed position to retain the trim to the associated vehicle.

A primary benefit of the present disclosure is the ease of installation of the trim.

Still another advantage relates to the application in wide array of end uses.

Yet another feature is the ability to ship the assembly to a customer as a single piece.

Still other features and benefits will be found in the following detailed description.

### BRIEF DESCRIPTION OF THE DRAWINGS

FIGS. 1 and 2 are schematic representations of an existing trim part and its installation as a B-pillar trim.

FIG. 3 is a perspective view of a trim panel in a preferred embodiment.

FIG. 4 is an enlarged perspective view of the disassembled components.

FIGS. 5 and 6 illustrate the first and second positions of the assembly and installation along an edge of an associated vehicle.

FIG. 7 is a perspective view schematically showing installation of the assembled trim.

FIGS. 8 and 9 are views similar to FIGS. 5 and 6 and illustrating the inclusion of a cut-line seal on the assembly and installation to the edge of a vehicle.

FIG. 10 is a cross-sectional view of an alternative embodiment of the seal retainer portion.

FIGS. 11 and 12 are cross-sectional views of the combined trim and retainer assembly in a first, shipping position and in a subsequent second or installed position.

### DETAILED DESCRIPTION OF THE PREFERRED EMBODIMENTS

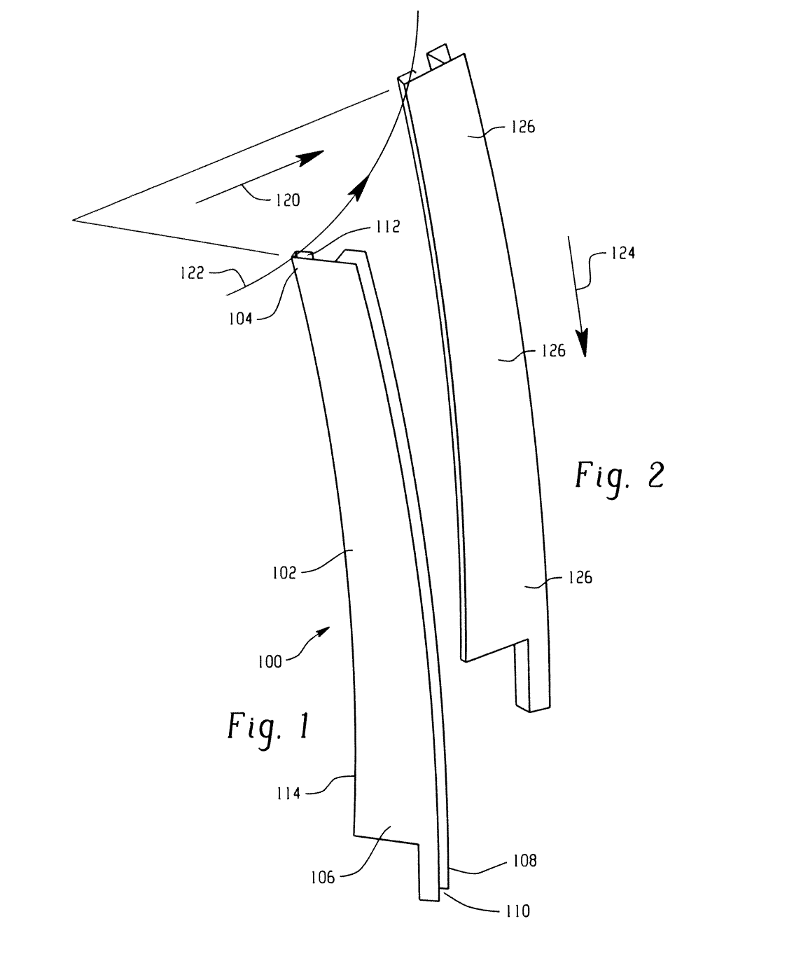

FIGS. 1 and 2 show a typical trim assembly, particularly a B-pillar trim member 100. The trim member is a generally elongated structure 102 having a first or upper end 104 and a second or lower end 106. Extending from the lower end 106 is a below belt portion 108 that has a conventional U-shaped channel structure or glass run channel 110 adapted to receive an edge of a movable window (not shown) in an associated vehicle door. This channel structure continues along the longitudinal extent of the structure 102 to the upper end 104. In this manner, the window edge is guided as it travels upwardly and downwardly relative to the trim member. The channel typically includes a glass run seal that seals about the edge of the window glass and aids in protecting the vehicle interior from the external environment.

While the glass run channel 110 extends along one longitudinal edge, an L-shaped hook 112 extends along the opposite edge of the trim member. The L-shaped hook 112 extends from a rear face of a panel or appliqué portion 114 that is a generally planar structure that overlies a portion of an associated automotive vehicle adjacent an edge of the vehicle sheet metal. For example, the appliqué is mounted to a B-pillar between the front and rear windows of an automotive vehicle. More specifically, and with combined reference to FIGS. 1 and 2, the hook 112 is dimensioned to be received over an edge or flange of the vehicle, such as a rear door edge of the B-pillar. The hook 112 is positioned along the rear door edge of the B-pillar and hooked or mounted over the edge. This is represented by reference numeral 120. Reference numeral 122 then illustrates that the trim member is subsequently rotated toward the door so that the show panel or appliqué 114 overlies the generally planar surface of the vehicle. Next, the trim member is then slid downwardly as represented by reference numeral 124 to the final mounted position of the trim member on the vehicle. Thereafter, the clips or fasteners 126 are installed along the appliqué portion to secure the trim member to the vehicle. Thus as is evident, the current arrangement requires the trim member to be rotated, and slid down into position in order to wrap the cut-line area flange or edge. This difficult to load procedure limits the amount of flange that can be covered, and also limits the length of the below belt portion of the glass run channel. Moreover, this installation procedure and structural arrangement has a potential for damaging a painted surface because of this multi-step installation process.

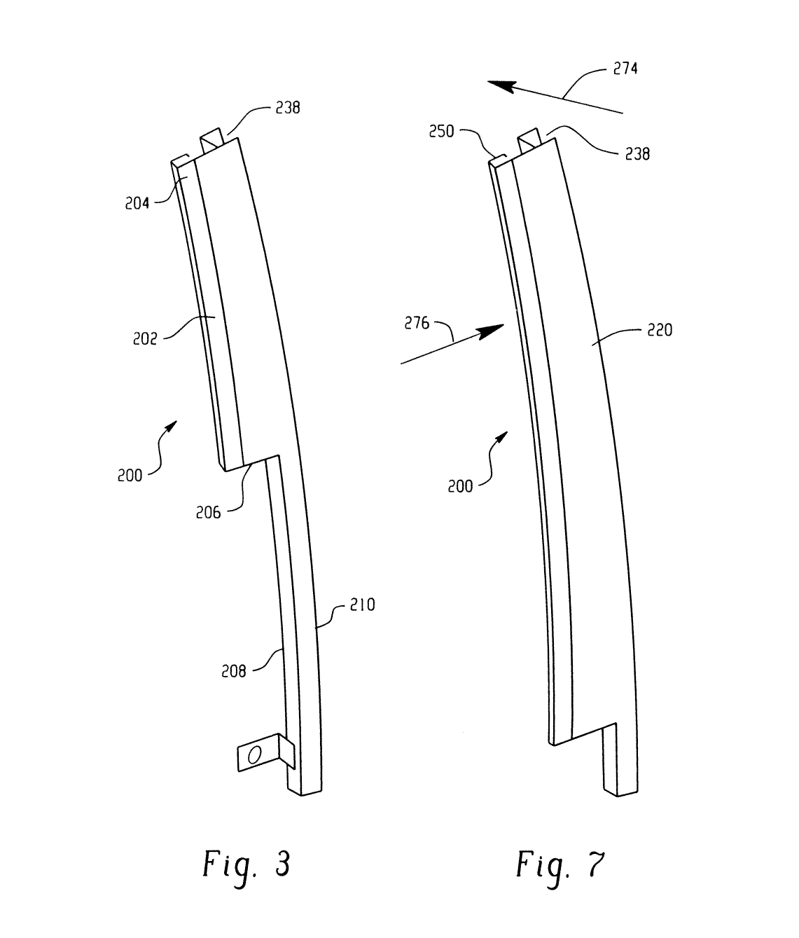

Shown in FIG. 3 is a trim or weatherstrip assembly 200 of the present disclosure. For ease of illustration and reference, a first embodiment of the assembly will be described with reference to a B-pillar trim application. The trim member 200 is also an elongated structure 202 having a first or upper end 204 and a second or lower end 206. Noticeably different is the length of a below belt portion 208. This allows a glass run channel 210 to be extended and continues through the belt line which results in improved glass guiding and elimination of separate below belt components. Because of the complex mounting arrangement of the prior art illustrated in FIGS. 1 and 2, such an extended glass run channel through the belt line is not possible with current appliqués that must necessarily be wrapped about the cut-line sheet metal.

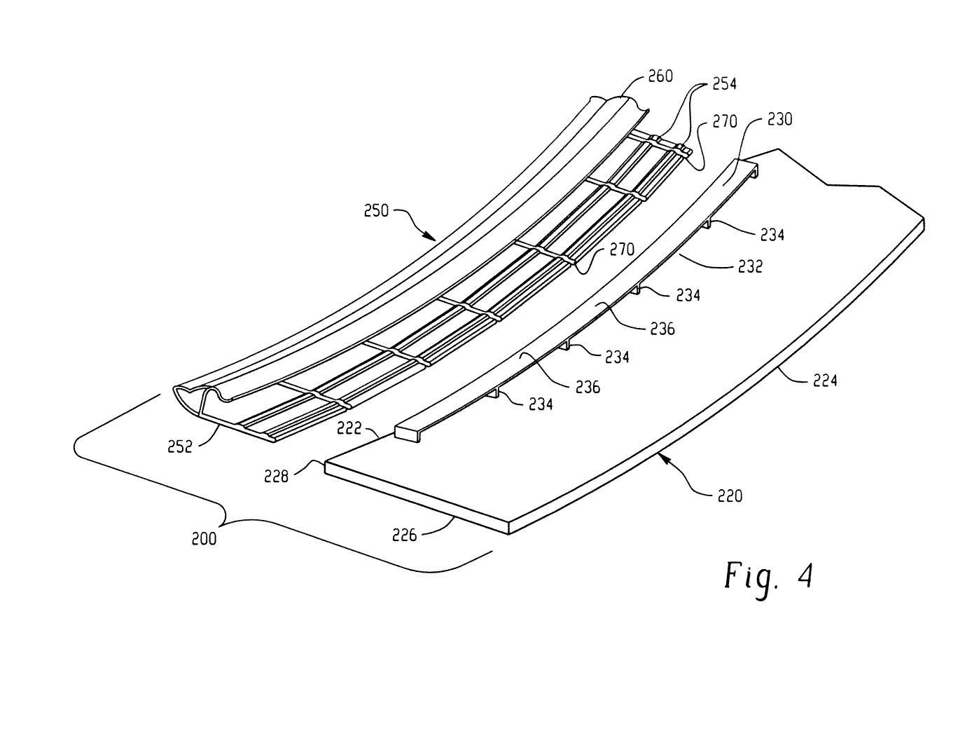

With continued reference to FIG. 3, and additional reference to FIGS. 4-6, the structure and method of installation of the preferred weatherstrip assembly or trim member will be described in greater detail. Particularly, as evident in FIG. 4, the weatherstrip or trim assembly is comprised of two components that are joined together. Specifically, a generally planar pillar trim portion 220 is received over a B-pillar of an automotive vehicle, and dimensioned to overlie and cover the B-pillar metal portion of the vehicle. A first longitudinal edge 222 runs generally parallel to a second edge 224, and each extending from the upper end 204 to the lower end 206. The dimension between the first and second edges 222, 224 may vary as required by the B-pillar dimensioning, however it will be appreciated that the trim portion has a first or outer surface 226 that has a desired texture, gloss, finish, etc. to provide the desired aesthetics for the vehicle. A second or inner surface 228 is disposed in facing relation with the B-pillar.

A connection member 230 extends from the inner surface 228 and is thus operatively associated with the cover portion 226 but on an opposite surface thereof. The connection member in the illustrated embodiment is preferably one or more channels 232 defined by stanchions or pillar portions 234 that are interconnected by spanning portions 236. The spanning portions and pillars thus define a series of adjacent channels that form the connection member on the trim portion 220 of the assembly. It will also be appreciated that the spanning portions have a predetermined dimension in an insertion direction i.e., from the first edge 222 toward the second edge 224, for reasons which will be described in further detail below.

The second or inner surface 228, or second edge 224 may also include a glass run channel 238 (FIGS. 3 and 7) formed therein. The channel is dimensioned to receive a seal assembly therein, such as a separate insertable seal assembly (not shown) that includes seal lips that engage opposite faces of the window along the edge and/or may include a high impact, low friction surface in a base portion of the channel. It is also contemplated that the glass run channel can include an integrated seal assembly formed directly on portions of the channel, rather than a separate insertable seal arrangement.

The trim member assembly 200 includes a second or fastener portion 250. The fastener portion has a generally J-shaped configuration in which an elongated first leg 252 includes a detent connection member 254. In the preferred embodiment, the detent connection member includes first and second engaging portions or shoulders 256, 258 that are spaced apart in the direction of insertion, i.e., from a terminal end of the first leg 252 toward the second leg 260. Moreover, the first and second shoulders 256, 258 of the detent connection member extend different heights from the leg, and preferably the second engaging shoulder has a greater height than the first shoulder 256.

The second leg 260 has a curvilinear contour that facilitates insertion of the fastener portion over the exposed sheet metal edge of the vehicle. For example, as illustrated in FIG. 6, the second leg is spaced from the spanning portion 236 a dimension slightly less than the width of the combined inner and outer door panels so that the fastener portion 250 grippingly engages the edge of the door. Preferably, the detent connection members of the fastener portion are divided into individual segments. That is, individual cutouts 270 divide the detent connection member into individual segments that are longitudinally spaced apart, and dimensioned and aligned for mating receipt of the pillars 234 of the trim portion. In this manner, the first leg 252 of the fastener portion is inserted into the individual channels 232 and a first, predetermined force is required to insert the first shoulder 256 beneath the spanning portion 236 whereby the first shoulder exits at the opposite end of the spanning portion and holds the trim portion 220 to the fastener portion. This relative position between the trim and fastener portions is defined as a shipping or first position of the trim assembly. The shipping position allows the fastener portion or retainer to be shipped with the trim member as a single piece from the supplier for installation by the OEM on the assembly line.

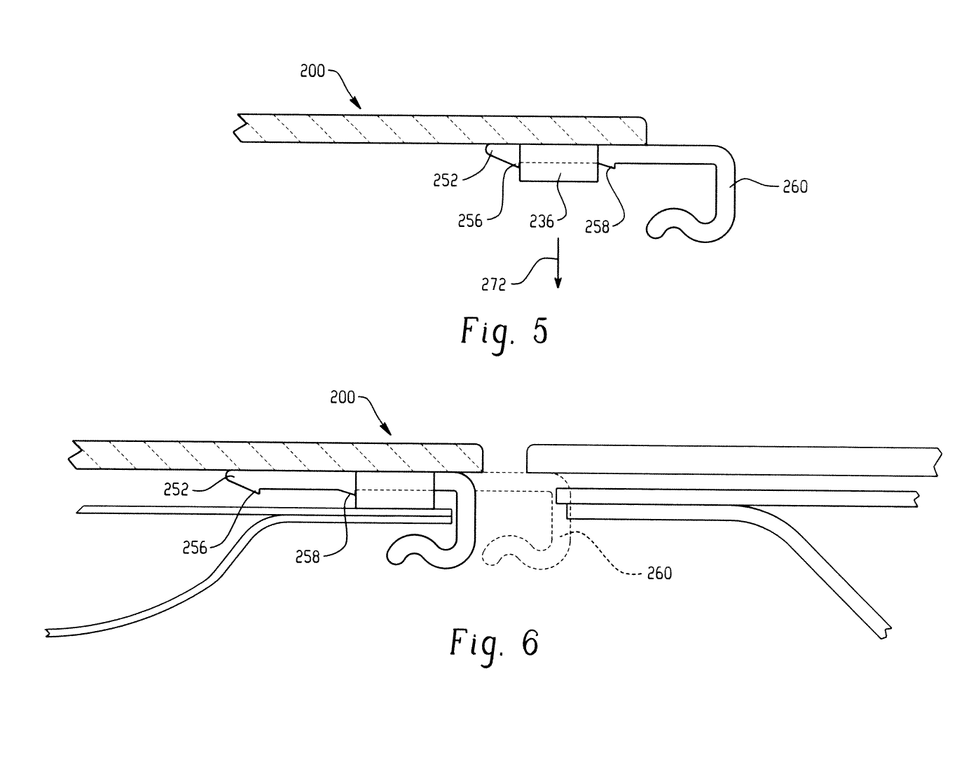

Thus, as more particularly shown in FIGS. 5 and 6, the first shoulder 256 is on one side of a spanning portion 236 while the second shoulder 258 is disposed on the other side in the first or shipping position. In this shipping position, the assembly can be handled by an assembly line operator/assembler and advanced as a single component in a direction perpendicular to the vehicle surface i.e., as shown by reference numeral 272. Once the assembly abuts against the B-pillar, for example, the fastener portion, and particularly the detent connection member, is moved to a second or installed position as shown in FIG. 6. Specifically, a second predetermined force is required to insert the second shoulder 258 beneath the spanning portion 236. Once the second shoulder 258 exits the opposite side of the spanning portion, the second shoulder 258 serves to prevent inadvertent removal of the trim portion from the fastener portion. Likewise, the thicker region of the fastener portion behind the second shoulder adds additional force to the gripping engagement of the first leg 252 and further secures the assembly to the edge of the associated vehicle.

The trim is typically a plastic material but can be formed of other materials as well. If plastic, formation of the channels 232 is easier as a molded component rather than an extruded component. The cross-sectional shape of the fastener portion, on the other hand, lends itself to being extruded, and subsequently, the first leg is modified to form the cutouts 270. Of course, as noted, portions of the trim can be extruded but it will be appreciated that the components can be molded as a single shot or alternatively as a dual shot structure.

FIG. 7 provides a simplified representation of the installation method. That is, the assembly 200 defined by the joined trim portion 220 and fastener portion 250, disposed in the first, shipping position, is directed perpendicularly toward the vehicle surface as represented by reference numeral 274. Once the assembly is located against the vehicle surface along the cut edge, the line operator then completes the installation by applying a force in the direction of reference numeral 276 that moves the fastener portion relative to the trim portion. More specifically, the applied force represented by reference numeral 276 advances the second shoulder 258 beneath the spanning portion 236 of the channels to dispose the trim portion and fastener portions in an installed, second position.

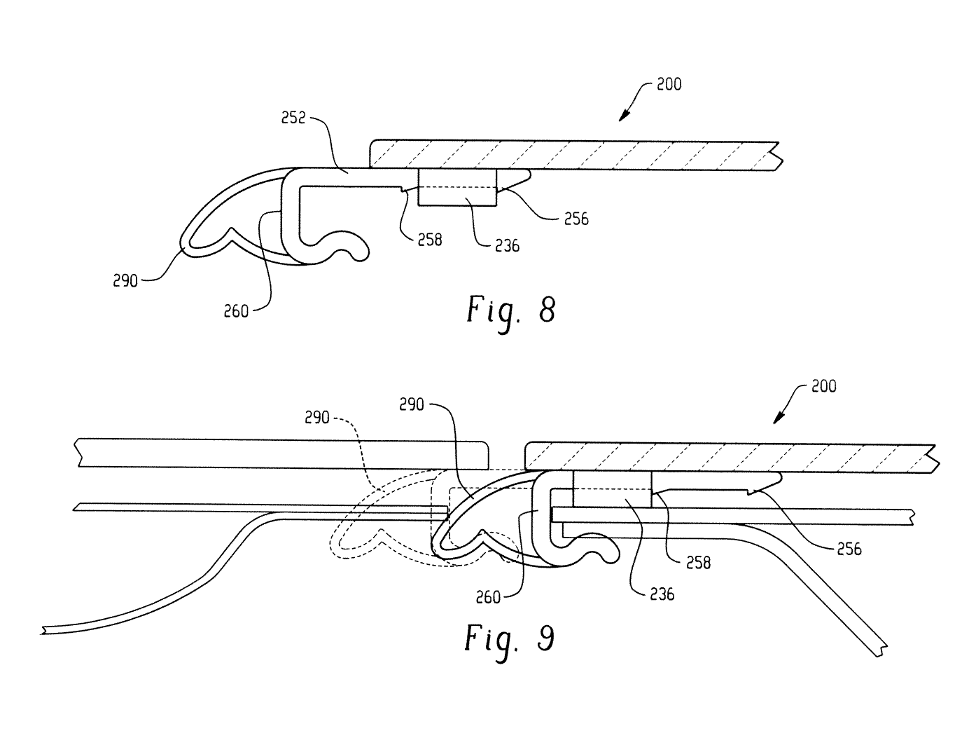

FIGS. 8 and 9 illustrate a related embodiment in which a cut-line seal 290 is added to the fastener portion. In all other respects, the structure and operation of the weatherstrip assembly is substantially identical to that described above. The seal may be a bulb type seal 290, or any other conventional seal configuration. The seal may also be advantageously coextruded with the remainder of the fastener portion due to the cross-sectional profile of this component. When installed for example on a rear door, the seal is adapted to engage the vehicle opening along a periphery of the rear door. Like FIG. 6, the illustration of FIG. 9 shows the weatherstrip assembly in the shipping position in broken line and the second, installed position in solid line.

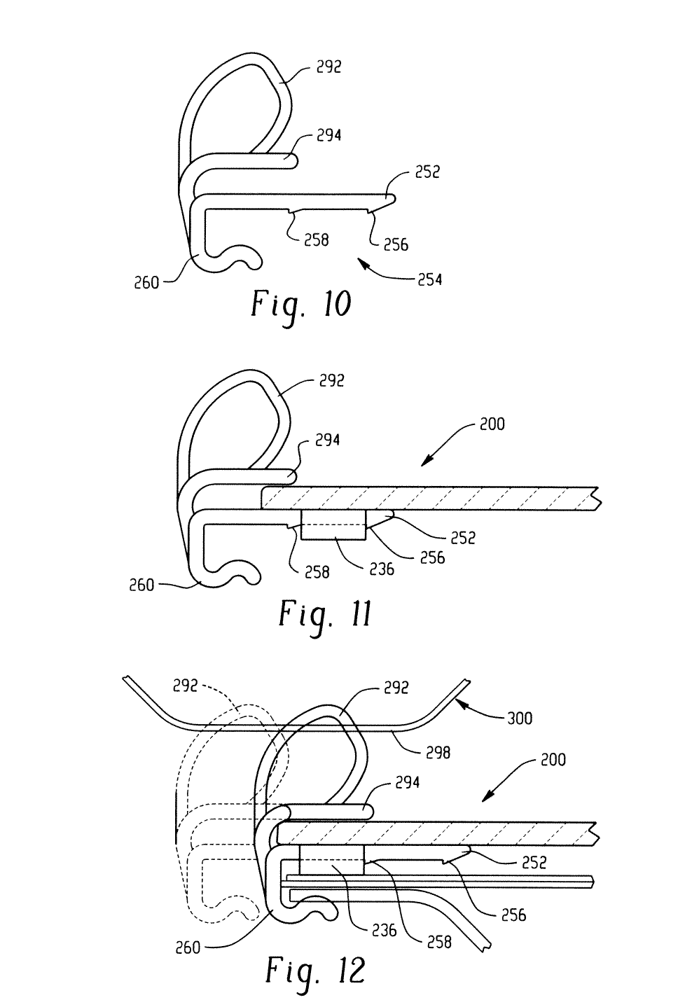

FIGS. 10-12 illustrate yet another embodiment of the weatherstrip assembly. In this arrangement, seal 292 is a hollow bulb type seal that is mounted on extension 294 and extends outwardly from the fastener portion 250. The extension is spaced from the first leg 252 to wrap around and accommodate, for example, a cowl or radiator trim element. The extension positions the seal 292 for engagement with an adjacent surface 298 such as a hood or trunk 300 (FIG. 12), etc. Again, the dotted line representation in FIG. 12 indicates the shipping position of the fastener portion which is actuated to the installation position.

The various embodiments illustrate a concept that allows the trim or weatherstrip assembly to be shipped to a customer as one part, while facilitating the elimination of retention clips or holes in the vehicle sheet metal. It also allows the part to be installed to the door in one linear motion rather than a complex series of installation steps. The components of the trim or weatherstrip assembly can be rigid or flexible plastics, EPDMs, or any other materials typically used in a trim or sealing application. The trim/weatherstrip assembly will also find use in a variety of automotive applications where a weatherstrip or trim part is used to enhance the vehicle appearance, help functionality, or cover sheet metal. For example, the door pillar trim, hood to cowl trim, hood to fender trim, hood to radiator trim, liftgate and sliding panel trim, are just other examples that are not intended to be limiting. This arrangement eliminates the use of additional fasteners, allows the use of inexpensive materials, and more importantly simplifies installation.

The invention has been described with reference to the preferred embodiment. Modifications and alterations will occur to others upon reading and understanding this specification. It is intended to include all such modifications and alterations in so far as they come within the scope of the appended claims or the equivalents thereof.

1. A trim/weatherstrip assembly for securing to an associated vehicle, the assembly comprising:
a cover portion dimensioned to overlie the associated vehicle adjacent an edge, and a connection member operatively associated with the cover portion; and
a fastener portion dimensioned for engaging receipt on the associated vehicle, the fastener portion including a detent connection member that includes first and second portions for operatively and alternatively engaging the connection member in a shipping, first position and in an installed, second position.

2. The assembly of claim 1 wherein the cover portion is an appliqué that aesthetically covers a preselected region of the associated vehicle adjacent the edge.

3. The assembly of claim 1 wherein the detent connection member of the fastener portion includes a first shoulder that engages the connection member of the cover portion in the shipping position, and a second shoulder spaced from the first shoulder that engages the connection in the installed position.

4. The assembly of claim 1 further comprising a seal member extending outwardly from one of the cover portion and the fastener portion for engagement with the associated vehicle.

5. The assembly of claim 4 wherein the seal member is integrally formed with the fastener portion.

6. The assembly of claim 1 wherein the fastener portion includes a first hook member dimensioned for receipt over the associated edge of a vehicle.

7. The assembly of claim 6 wherein the hook member includes an open portion disposed in facing relation with the associated edge of the vehicle in the first position and received over the associated edge of the vehicle in the second position.

8. The assembly of claim 7 wherein the hook member is generally J-shaped and includes a terminal end that is dimensioned for receipt on a first surface of the edge of an associated vehicle, and the detent connection member extending from the terminal end and spaced therefrom for receipt on a second, opposed surface of the edge of the associated vehicle.

9. The assembly of claim 1 wherein the assembly is one of an elastomer and plastomer.

10. The assembly of claim 9 wherein the trim is a rigid material.

11. A method of manufacturing a weatherstrip or trim assembly for use on an associated vehicle comprising:
providing a cover portion dimensioned to overlie the associated vehicle adjacent an edge, and a connection member operatively associated with the cover portion; and
providing a fastener portion dimensioned for engaging receipt on the associated vehicle, the fastener portion including a detent connection member that includes first and second portions for operatively and alternatively engaging the connection member in a shipping, first position and in an installed, second position.

12. The method of claim 11 including forming the connection member as a channel dimensioned to receive the detent connection member therethrough.

13. The method of claim 11 including forming the detent connection member as first and second shoulders spaced apart in a direction of insertion into the connection member.

14. The method of claim 13 wherein the first shoulder extends a first height above the detent connection member and the second shoulder extends a different, second height above the detent connection member.

15. The method of claim 14 wherein the second height is greater than the first height.

16. The method of claim 11 wherein the fastener portion providing step includes extruding the fastener portion.

17. The method of claim 16 wherein the fastener providing step further includes co-extruding a flexible seal.

18. The method of claim 16 further comprising cutting the extruded fastener portion into segments.

19. The method of claim 11 including forming the connection member as a channel dimensioned to receive the detent connection member therethrough, and forming the detent connection member as first and second shoulders spaced apart in a direction of insertion into the connection member, the channel having a depth that is greater than a spacing between the first and second shoulders.

20. A method of installing a trim to an associated vehicle having a cover region adjacent an edge, the trim including a movable detent connection member that has a shipping, first position spaced from the associated vehicle edge and an installed, second position for operatively engaging the trim to the associated vehicle edge, the method comprising:
advancing the trim generally perpendicular to the cover region with the detent connection member in the shipping position; and
moving the detent connection member to the installed position to retain the trim to the associated vehicle.

21. The method of claim 20 wherein the detent connection member moving step includes repositioning the detent connection member in a direction substantially perpendicular to the advancing direction.

22. The method of claim 21 wherein the trim engages a surface of the associated vehicle adjacent the edge in the installed position that is generally parallel to the cover region.
